(19) United States
(12) Patent Application Publication
(10) Pub. No.: US 2026/0281183 A1
(43) Pub. Date: Sep. 17, 2026

(54) CLOUD-BASED LABORATORY MONITORING APPLICATION

(71) Applicants: Laurin Oberhauser, Schaanwald (LI); Adrian Wegiel, Schaanwald (LI)

(72) Inventors: Laurin Oberhauser, Schaanwald (LI); Adrian Wegiel, Schaanwald (LI)

(21) Appl. No.: 19/078,292

(22) Filed: Mar. 13, 2025

(51) Int. Cl. H04L 67/125; H04L 67/75

(52) U.S. Cl. CPC H04L 67/125; H04L 67/75

(57) ABSTRACT

An embodiment of the present invention is a cloud-based method of laboratory monitoring, comprising: receiving data from one or more gateways to a cloud-based internet application by a Local Area Network, wherein one or more nodes having one or more environmental sensors are connected to the gateway by a Low Power Wide Area Network; displaying, on an electronic display screen, the number of gateways and nodes online; displaying, on an electronic display screen, the locations of gateways and nodes online; displaying, on an electronic display screen, one or more environmental parameters; displaying, on an electronic display screen, one or more alarm indications in the received data; and displaying, on an electronic display screen, one or more door opening indications in the received data.

### BACKGROUND

Applications for laboratory monitoring dashboards have been described in the prior art patent literature.

For example, U.S. Pat. No. 10,228,837 discloses an intuitive dashboard framework for creating, managing and publishing a collection of visualization gadgets for critical environments. It may further reveal intelligent gadgets to visualize critical environmental data in wet chemistry laboratories, and a healthcare and life science environment that are easy to configure, customize and deploy for a web dashboard presentation. The present approach may provide a way for facility personnel to easily identify problems, check system status, monitor safety hazards and certification data with certain equipment, build monthly reports, and make setpoint changes in an easy to understand manner. With the present approach, facility personnel do not necessarily have to either contact a controls partner for service, or come through factory training and become an expert on the respective system to understand how the system works and to make changes.

U.S. Pat. No. 11,226,126 discloses a method for generating and updating a live dashboard of a building management system for a building, the method comprising: generating, by the building management system, a dashboard designer interface and causing the dashboard designer interface to be displayed on a user device of a user; receiving, by the building management system via the dashboard designer interface, a graphic element from the user, wherein the graphic element comprises a renderable visual element and one or more strings embedded within the graphic element that define rules for drawing a plurality of first shapes that make up a visual appearance of the renderable visual element when rendered; executing, by the building management system, a widget of the live dashboard separate from the graphic element to access the one or more strings embedded within the graphic element and modify the one or more strings to define second rules for drawing a plurality of second shapes that change the visual appearance of the renderable visual element when the renderable visual element is rendered; receiving, by the building management system, a value for a data point from building equipment; and rendering, by the building management system, the renderable visual element based on the value for the data point and the one or more strings.

However, prior art dashboards suffer from limitations including the inability to conveniently monitor a plurality of locations and sublocations.

### SUMMARY OF INVENTION

Therefore, the present invention provides the ability to monitor multiple hubs and nodes across a variety of laboratory settings in a cloud-based application. The laboratory environment can be monitored remotely, including environmental conditions such as CO2 pressure and temperature, using the cloud-based application. Door opening and closings can be monitored and controlled, and permissions can be set for particular users to unlock specific doors. Power consumption can be monitored to identify power usage patterns, optimize energy consumption or detect potential irregularities before they become an issue. If a compressor or other equipment such as a heater is needing more power to keep the temperature at a level, it could be a fluid leak, or other indication of a mechanical problem. Laboratories in multiple disparate geographic regions can be monitored, and users can drill down to particular sublocations within those laboratories.

According to an aspect of the present invention, there is provided a cloud-based method of laboratory monitoring, comprising: receiving data from one or more gateways to a cloud-based internet application by a Local Area Network, wherein one or more nodes having one or more environmental or power monitoring sensors are connected to the gateway by a Low Power Wide Area Network; displaying, on an electronic display screen, the number of gateways and nodes online; displaying, on an electronic display screen, the locations of gateways and nodes online; displaying, on an electronic display screen, one or more environmental parameters; displaying, on an electronic display screen, one or more alarm indications in the received data; and displaying, on an electronic display screen, one or more door opening indications in the received data.

### BRIEF DESCRIPTION OF THE DRAWINGS

FIG. 1 illustrates a laboratory monitoring dashboard according to an embodiment of the present invention.

FIG. 2 illustrates a cloud-based door access control report.

FIG. 3 illustrates a list of connected devices.

FIG. 4 illustrates a list of gateways.

FIG. 5 illustrates a list of users.

FIG. 6 illustrates a list of reports.

FIG. 7 illustrates creating a report.

FIG. 8 illustrates a list of alerts.

FIG. 9 illustrates creating an alert.

FIG. 10 illustrates a map of node and gateway devices.

FIG. 11 illustrates scheduling lights using the cloud platform.

### DETAILED DESCRIPTION

The cloud-based laboratory monitoring application according to the present invention includes a plurality of node devices connected to one or more gateway device by LPWAN, “Low Power Wide Area Network”, a kind of wireless telecommunication vast area network that engineers long-range communications at a low bit rate. LPWAN can be LoRaWAN®. Node devices do not use WiFi so as to not overload the WiFi bandwidth available in the location, e.g., the laboratory.

Instead, data from the node devices is sent to the one or more gateway devices which connects to the cloud by a network internet connection, i.e., a LAN connection. A WiFi connection can be used when the LAN connection not available. A preferred embodiment also has a SIM card for backup communications when the primary LAN connection and WPS connection are inoperative.

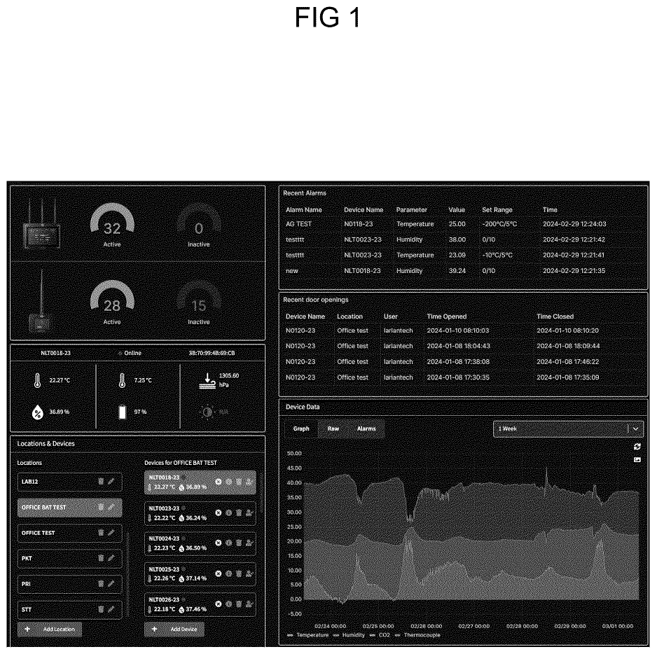

FIG. 1 illustrates a cloud-based laboratory monitoring dashboard according to an embodiment of the present invention.

The cloud-based laboratory monitoring dashboard displays the number of gateways online and the number of node devices online. The dashboard displays the locations of the gateways and nodes.

The dashboard displays all of the information which can be found on the gateway device displays so that a user may remotely monitor the laboratory environment as if the user was in the laboratory.

The dashboard displays an indication of the internet status (LAN, WI-FI or 4G SIM) based on which connection is operable and being utilized at a given time.

The dashboard can display preventive maintenance information, such as countdowns to scheduled and/or recommended maintenance intervals. The dashboard can display open support tickets, for example.

The dashboard can display the status of node devices, such as online or offline.

The dashboard displays active alarms based on data points measured by sensors associated with node devices exceeding predefined thresholds. The dashboard allows those thresholds to be set and revised.

The dashboard can display sensors for monitoring many custom parameters. Node devices can be provided for example with temperature sensors and data from those sensors displayed on the dashboard. Node devices can be provided for example with humidity sensors and data from those sensors displayed on the dashboard. Node devices can be provided with sensors for measuring the concentration of carbon dioxide, oxygen, or other gases and data from those sensors displayed on the dashboard. Node devices can also measure ambient pressure and readings can be displayed on the dashboard. Node devices can be provided with fluid level sensors. The sensor can detect if fluid falls below a set threshold, and an alarm displayed on the dashboard if so. A variety of other custom environmental sensors can be provided in node devices specific to the particular site, and data from those sensors can be displayed on the dashboard.

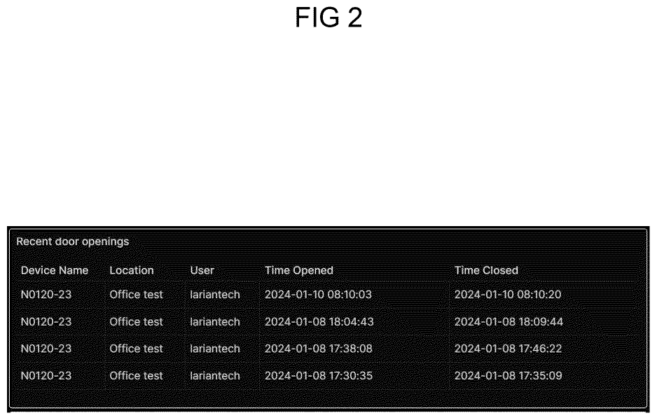

FIG. 2 illustrates a cloud-based door access device control according to an embodiment of the present invention.

Node devices can be provided with proximity sensors to measure door opening and closing. The sensors can be provided on the door as well as on the node and a processor can calculate based on the positions whether the door is open or closed. A lock can be provided in combination with a sensor and a password can be entered on the node device to open the lock.

Passwords are hard coded in nodes. Every password is linked to a user, and the node devices can be updated by over-the-air updates to change

### The Passwords Stored.

Door access can also be set using the present invention. An administrative user has a list of passwords that correspond to users e.g user 4. While adding a user on the cloud an option to choose a user, e.g user 4, from a list is given. If the user, i.e., user 4 now opens the door using the password provided the present invention monitors and records the door opening and displays that the door has been opened by e.g., user 4. The opening/closing time and date will be displayed on the cloud software of the present invention.

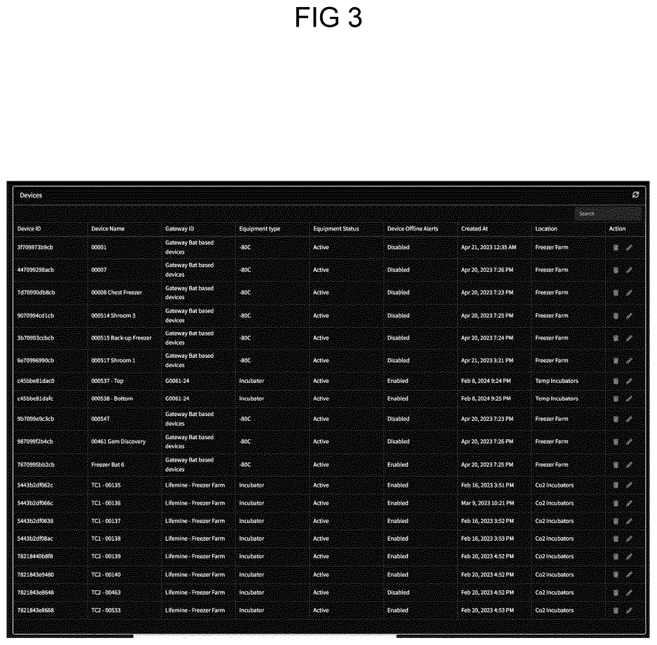

FIG. 3 illustrates a list of connected node devices.

The list shows the devices which are added to the cloud account. Node devices can be assigned to gateway devices using the cloud interface shown herein.

The node device will transmit to any gateway device in the area at a given frequency e.g., 915 MHz, and the gateway will just reject the data unless it is assigned to the node in the cloud software. The frequencies of the node devices can be set using the cloud interface or via an over the air update to the EEprom.

If a node device sends data to a gateway device it is not assigned to, the gateway device will reject the data packet and not respond to the node device. If a node device sends data to a gateway device it is assigned to, the gateway device will send a time to the node device for sending the next data packet. The time interval sent from the gateway to the node can be set using the cloud interface.

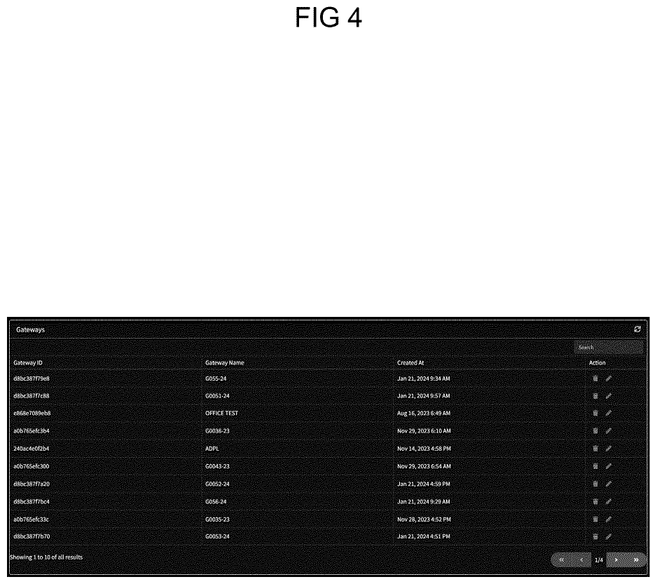

FIG. 4 illustrates a list of gateways.

The ID for the gateway is on a microchip inside the gateway. The gateway does not have a location. Only the node devices have a location. Each gateway needs a unique identifier (a MAC address), but the name can be set by the user to any name desired.

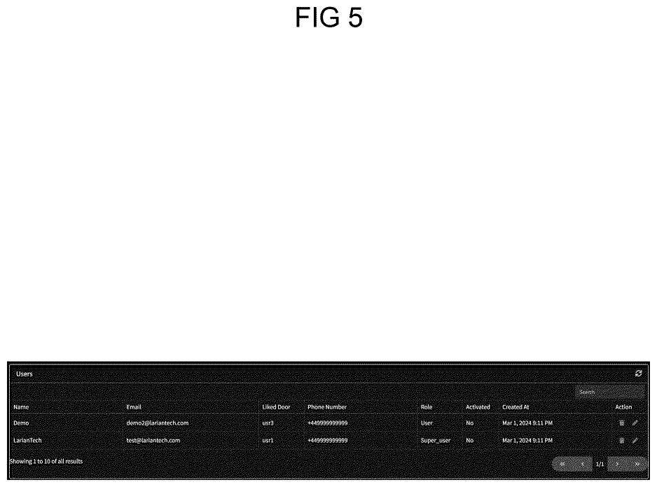

FIG. 5 illustrates a list of users.

Users can be assigned roles with more or less access. The admin user can assign sub-users to see various devices when using the sub-user's account. And, it is possible to create alert profiles for only the user device, and the user cannot change any admin settings that an admin user set. Multiple admin users can be assigned.

If a user gets added to the cloud, the user will receive an email with an activation link. If that link is not confirmed, the user will not have access, and the user will display on the list as not being active.

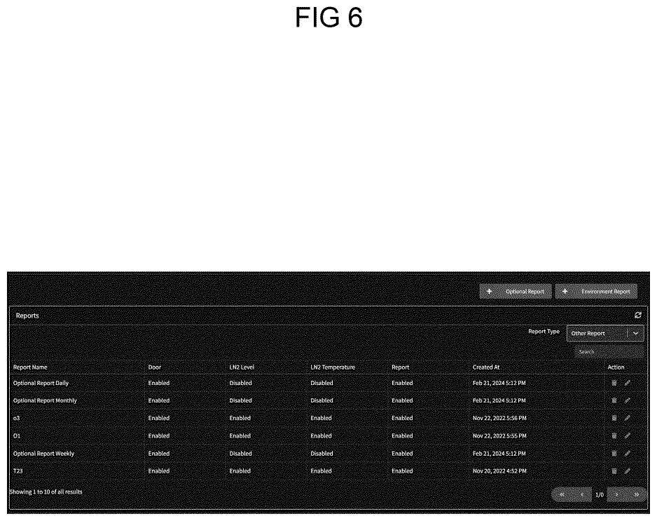

FIG. 6 illustrates a list of reports.

The reports, for example, can include information about temperature, humidity, and carbon dioxide levels during specified time periods and at preset intervals. Other custom sensors can also be used in reports (e.g., fluid level sensors). The reports can be configured to be sent to email addresses and/or by text message.

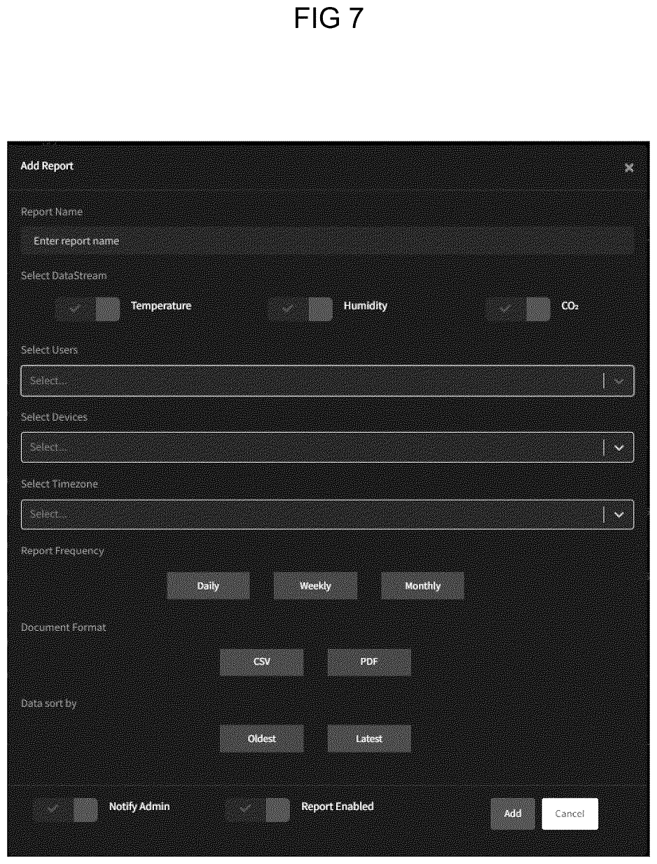

FIG. 7 illustrates creating a report.

The nodes included in the report, the frequency of the reporting, and the users who will receive the report can all be set. The format of the report, such as .csv and .pdf, can be set and the reports can be generated in that data format based on the parameters set by the user. The frequency of the report, e.g., daily, weekly, hourly, etc. can also be set.

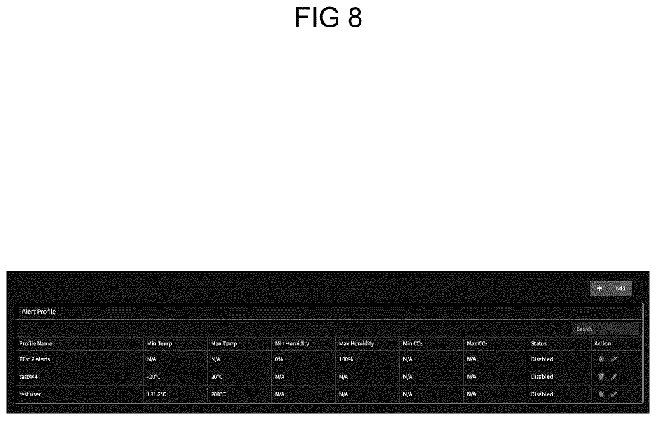

FIG. 8 illustrates a list of alerts.

Alert data can be stored in a database. The database is designed to automatically manage the lifecycle of time series data. Data may be stored for, e.g., in a hot storage and a cold storage. The present invention offers methods to transfer data between the two data stores-the in-memory store and a cost-effective magnetic store, and it supports configuring table level policies to automatically transfer data across stores. Incoming writes land in the memory store where data is optimized for writes, as well as reads performed around current time for powering dashboard and alerting type queries. When the main time-frame for writes, alerting, and dashboarding needs has passed, the data can automatically flow from the memory store to the magnetic store.

Users can pause or “snooze” the alerts by either updating the alert setting in the cloud or responding to the text message. The alert can pause until the parameter reaches the alarm value based on the range set in the cloud to resume alerts.

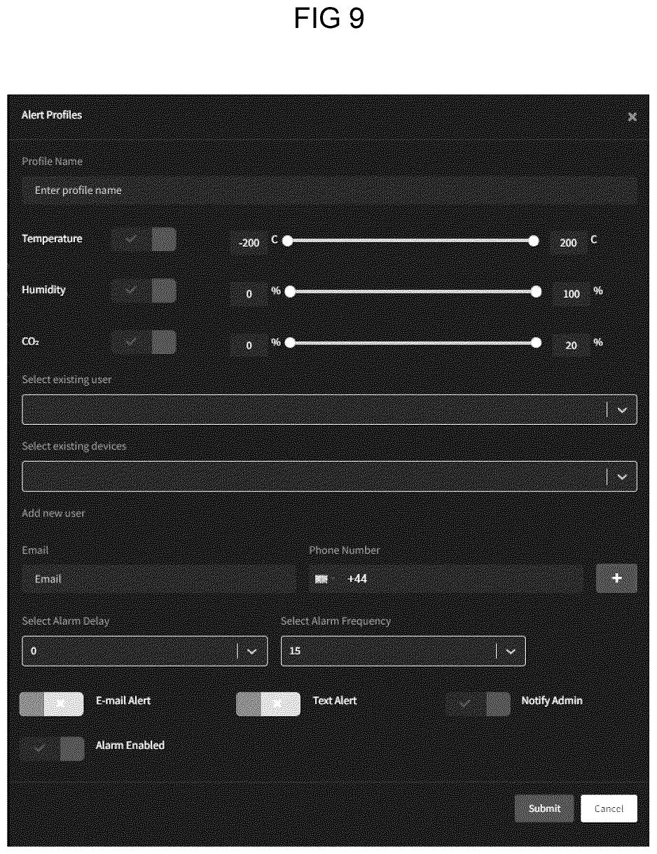

FIG. 9 illustrates creating an alert.

Ranges of tolerable or optimal temperatures, humidity, carbon dioxide levels, and other custom sensors such as fluid levels can be set and alerts generated and sent by email or text message when measurements are received from node devices which fall outside the set ranges.

Voice calls can be initiated according to parameters in the alert created in addition to SMS and e-mail alerts. Depending on the time of day users can set alerts to come by either voice calls (e.g., before or after 5 pm) or email (e.g., after or before 5 pm). The preferences can be set for each user, e.g., user 1 gets SMS alerts and user 2 gets email alerts.

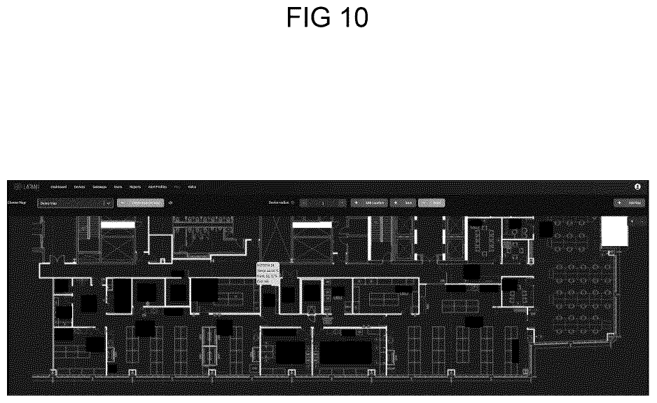

FIG. 10 illustrates a map of node and gateway devices.

A map can be provided of node and gateway devices. The node and gateway devices can be placed onto the map using the cloud software of the present invention. A floor plan can be uploaded for example as a .png file, and then a plurality of areas can be outlined. The user of the cloud software can then select from a drop down menu one of the areas where the devices should be and the devices can be linked by selecting a device from a drop down menu. The node devices can then be placed on the floor plan in a particular location. To move the location of a device within a room, a user can drag and drop it. To change the location of the device to another room, the user can first change the area with which it is associated.

The node and gateway devices can also be automatically placed on the map according to GPS. The map can be a floor plan for a laboratory, or can be a geographic map including multiple locations within the same city or in different cities.

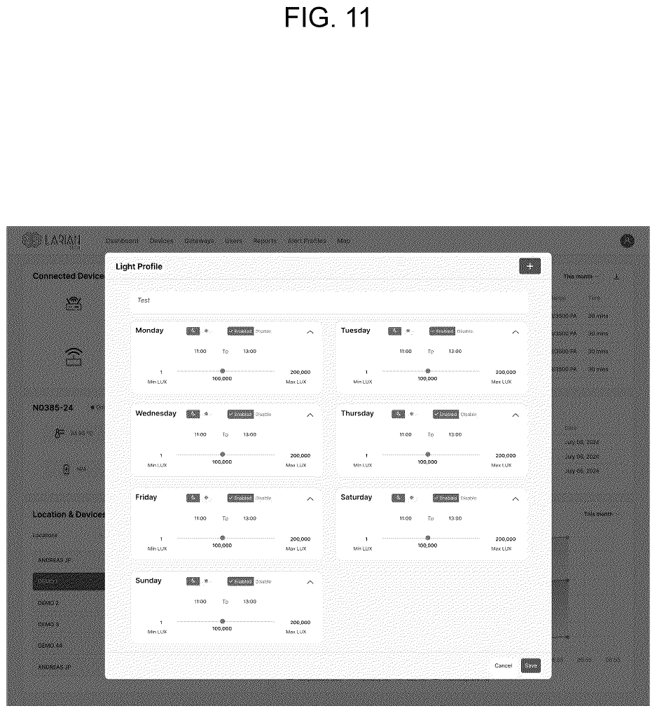

FIG. 11 illustrates scheduling lights using the cloud platform.

The users can set times regularly based on the day of the week (i.e., Monday, Tuesday, etc.) or individual calendar days. Admin users can control the lights for their entire cloud account, and sub-users can be given permission to control the alarms for the lights in particular locations or can be given no permission to control the alarms for the lights. The platform can utilize the light intensity sensor from the Node lite to create an alarm schedule. If a setpoint is exceeded, an alert can be sent. If, for example, the light is not off at a specific time, users will receive an alert.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A cloud-based method of laboratory monitoring, comprising:
receiving data from one or more gateways to a cloud-based internet application by a Local Area Network, wherein one or more nodes having one or more environmental sensors are connected to the gateway by a Low Power Wide Area Network;
displaying, on an electronic display screen, the number of gateways and nodes online;
displaying, on an electronic display screen, the locations of gateways and nodes online;
displaying, on an electronic display screen, one or more environmental parameters;
displaying, on an electronic display screen, one or more alarm indications in the received data; and
displaying, on an electronic display screen, one or more door opening indications in the received data.

2. The cloud-based method of laboratory monitoring of claim 1, further comprising:
receiving a password setting for accessing a door from a user in the cloud-based internet application;
transmitting the password setting to a door lock in a laboratory; and
transmitting an instruction to open the lock when the set password is entered on a node connected to the door lock.
